(19) United States
(12) Patent Application Publication
(10) Pub. No.: US 2026/0194710 A1
(43) Pub. Date: Jul. 9, 2026

(54) BONDED PHOTONIC STRUCTURES INCLUDING VERTICAL COUPLING INTERLAYER AND METHODS OF FABRICATION THEREOF

(71) Applicant: Taiwan Semiconductor Manufacturing Company Limited, Hsinchu (TW)

(72) Inventors: Kuo-Pin Chang, Zhubei City (TW); Hung-Ju Li, Hsinchu City (TW); Yu-Wei Ting, Taipei City (TW); Kuo-Ching Huang, Hsinchu City (TW)

(21) Appl. No.: 19/008,944

(22) Filed: Jan. 3, 2025

(51) Int. Cl. G02B 6/122; G02B 6/13

(52) U.S. Cl. CPC G02B 6/122; G02B 6/13

(57) ABSTRACT

Bonded photonic structures include a first integrated circuit (IC) photonic structure including first optical components, a second IC photonic structure including second optical components, and a vertical coupling interlayer (VCIL) structure including third optical component(s) located between the first IC photonic structure and the second IC photonic structure and configured to couple optical signals between the first optical components and the second optical components along a vertical direction. A first IC electronic die bonded to the first IC photonic structure provides an interface between the electronic and photonic components of the bonded photonic structure. By providing a bonded photonic structure having a vertically stacked, three-dimensional structure including the VCIL structure located between the first and second IC photonic structures, optical signals may be routed vertically between the first and second IC photonic structures, enabling a compact design with improved optical isolation, coupling efficiency and insertion loss characteristics.

### BACKGROUND

Semiconductor devices are used in a variety of electronic applications, such as personal computers, cell phones, digital cameras, and other electronic equipment. Semiconductor devices are typically fabricated by sequentially depositing insulating or dielectric layers, conductive layers, and semiconductive layers of material over a semiconductor substrate, and patterning the various material layers using lithography to form circuit components and elements thereon. Dozens, hundreds, or thousands of integrated circuits are typically manufactured on a single semiconductor wafer, and individual dies on the wafer are singulated by sawing between the integrated circuits along scribe lines. The individual dies are typically packaged separately, in multi-chip modules, or in other types of packaging, for example.

To provide improved performance characteristics, such higher-speed, lower-latency, and more energy-efficient data transmission systems, silicon photonics is emerging as an important technology. Silicon photonics may enable optical components, such as waveguides, modulators, and photodetectors, to be integrated with electronic components in a single package. However, there remain many challenges related to the integration of electronic and photonics components in a single package.

### BRIEF DESCRIPTION OF THE DRAWINGS

Aspects of this disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A is a vertical cross-sectional view of a first integrated circuit (IC) photonic structure according to various embodiments of the present disclosure.

FIG. 1B is a vertical cross-sectional view of a second integrated circuit (IC) photonic structure according to various embodiments of the present disclosure.

FIG. 1C is a vertical cross-sectional view of a vertical coupling interlayer (VCIL) structure according to various embodiments of the present disclosure.

FIG. 2 is a vertical cross-sectional view illustrating the second IC photonic structure bonded to the VCIL structure according to various embodiments of the present disclosure.

FIG. 3 is a vertical cross-sectional view illustrating the VCIL structure bonded to the first IC photonic structure to form a bonded photonic structure according to various embodiments of the present disclosure.

FIG. 4 is a vertical cross-sectional view of a bonded photonic die including a first IC electronic die bonded to a first IC photonic structure and a second IC electronic die bonded to a second IC photonic structure and a VLIC structure located between the first IC photonic structure and the second IC photonic structure according to various embodiments of the present disclosure.

FIG. 5 is a is a vertical cross-sectional view of a bonded photonic die according to another embodiment of the present disclosure.

FIGS. 6A and 6B are side perspective views of a portion of a bonded photonic die schematically illustrating the routing of optical signals using wavelength-selective vertical coupling according to various embodiments of the present disclosure.

FIG. 7 is a vertical cross section view of a semiconductor package structure according to an embodiment of the present disclosure

FIG. 8 is a vertical cross section view of a semiconductor package structure according to another embodiment of the present disclosure.

FIG. 9 is a flowchart illustrating a method of fabricating a bonded photonic die according to various embodiments of the present disclosure.

### DETAILED DESCRIPTION

The following disclosure provides many different embodiments, or examples, for implementing various features of the provided subject matter. Specific examples of components and arrangements are described below to simplify this disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, this disclosure may repeat reference numerals and/or letters in the disclosed example embodiments. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. Unless explicitly stated otherwise, each element having the same reference numeral is presumed to have the same material composition and to have a thickness within a same thickness range.

Typically, in a semiconductor package, a number of semiconductor integrated circuit (IC) dies (i.e., “chips”) may be mounted onto a common substrate, which may also be referred to as a “package substrate.” The semiconductor IC dies of the semiconductor package may include various types of dies, such as logic die(s) (e.g., CPU die(s), GPU die(s), ASIC die(s), etc.), memory die(s) (e.g., SRAM die(s), HBM die(s), etc.), analog die(s), RF die(s), and the like. In some cases, the semiconductor IC dies of the semiconductor package may include one or more integrated circuit (IC) photonic dies including optical components (e.g., light source(s), optical detector(s), optical modulator(s), etc.) that may be configured to generate, transmit, receive and/or modify optical signals (i.e., photons). Each IC photonic die may be operatively coupled to an IC electronic die that may be configured to provide an interface between photonic and electronic components of the semiconductor package. An IC photonic die utilizing optical signals may provide higher bandwidth and speed and lower power consumption than an equivalent IC die utilizing only electrical signals. This may make semiconductor packages including IC electronic dies integrated with IC photonic dies an attractive option for advanced computing applications, such as computing-in-memory (CIM) applications.

However, in instances in which IC photonic dies and IC electronic dies are integrated with one another it may be desirable to have relatively larger chip areas and complex optical routing designs. This may hinder the applications of the semiconductor package, increase the difficulty of circuit design and fabrication and add to the overall complexity of the semiconductor package. In addition, the complex optical routing design may lead to low coupling efficiency and high insertion loss.

The various embodiments disclosed herein may include bonded photonic structures, including bonded photonic dies, that integrate photonic integrated circuit (IC) devices and electronic IC devices. In various embodiments, a bonded photonic die may include a first IC photonic structure including first optical components, a second IC photonic structure including second optical components, and a vertical coupling interlayer (VCIL) structure including at least one third optical component located between the first IC photonic structure and the second IC photonic structure, where the least one third optical component of the VCIL structure couples optical signals between first optical components of the first IC photonic structure and second optical components of the second IC photonic structure along a vertical direction. In various embodiments, the VCIL structure may be bonded to the first IC photonic die and to the second IC photonic die via a suitable bonding process, such as a fusion bonding process. A first IC electronic die may be bonded to the first IC photonic structure and may provide an interface between the electronic and photonic components of the bonded photonic die. In some embodiments, a second IC electronic die may also be bonded to the second IC photonic structure and may provide an equivalent function.

A bonded photonic die according to various embodiments may enable routing of optical signals between the first IC photonic structure and the second IC photonic structure. By providing a bonded photonic die having a vertically stacked, three-dimensional structure including the VCIL structure located between the first IC photonic structure and the second IC photonic structure, optical signals in the bonded photonic die may be transmitted along a vertical direction between the first IC photonic structure and the second IC photonic structure via the third optical component(s) in the VCIL structure. This may enable a compact design with improved flexibility in the routing of optical signals. In addition, the presence of the VCIL structure may provide increased optical isolation between optical components (e.g., waveguides) located in the first IC photonic structure and the second IC photonic structure, which may suppress optical coupling between the different optical components and may help to reduce optical cross-talk. Accordingly, coupling efficiency and insertion loss characteristics of the bonded photonic die may be improved.

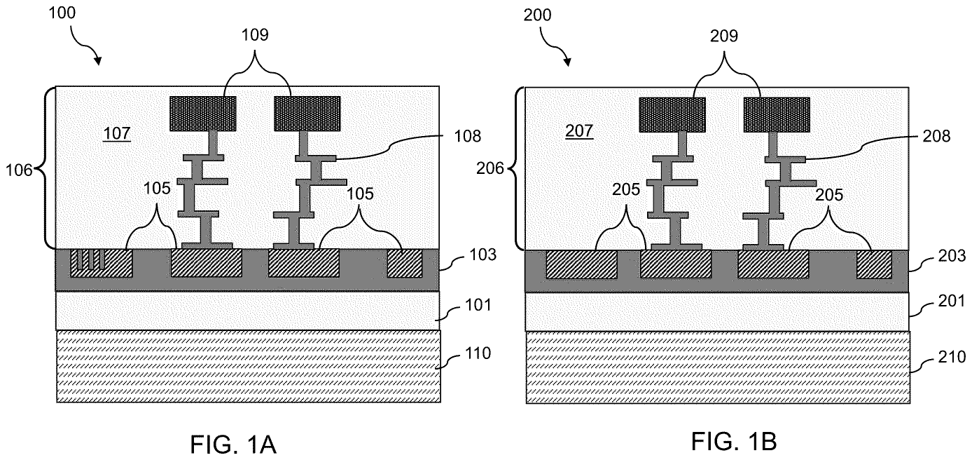

FIG. 1A is a vertical cross-sectional view of a first integrated circuit (IC) photonic structure 100 according to various embodiments of the present disclosure. Referring to FIG. 1A, in various embodiments, the first IC photonic structure 100 may include a first insulator layer 101, a first semiconductor layer 103 over the first insulator layer 101, and a first interconnect structure 106 over the first semiconductor layer 103. In various embodiments, the first insulator layer 101 may be located over a first support substrate 110 that may provide mechanical support for the first IC photonic structure 100. The first support substrate 110 may include any suitable substrate materials, such as a semiconductor (e.g., silicon) material, an organic material, a glass material, a ceramic material, etc. In some embodiments, the first insulator layer 101 and the first semiconductor layer 103 of the first IC photonic structure 100 may include a silicon-on-insulator (SOI) structure. The SOI structure may include a buried insulator layer 101, such as an oxide layer (e.g., a silicon oxide layer), located between an upper layer 103 composed of an epitaxial semiconductor material (e.g., single-or polycrystalline silicon) and a lower substrate 110 that may be composed of a semiconductor material (e.g., bulk silicon). However, it will be understood that other materials and/or configurations of the first insulator layer 101, the first semiconductor layer 103 and the first substrate 110 are within the contemplated scope of disclosure.

Referring again to FIG. 1A, a plurality of first optical components 105 may be formed in the first semiconductor layer 103 according to various embodiments. The first optical components 105 may include optical and/or electro-optical components, such as one or more waveguides, resonators, interferometers (e.g., Mach-Zehnder Interferometers (MZIs)), lenses, gratings, splitters, mirrors, optical amplifiers, optical modulators, filters, light sources (e.g., laser(s) or LED(s)), heaters, and/or optical detectors. Other suitable first optical components 105 are within the contemplated scope of disclosure.

In various embodiments, the first optical components 105 may be fabricated by patterning the first semiconductor layer 103 to define features of the first optical components 105. The patterning of the first semiconductor layer 103 may be performed using photolithographic techniques. A layer of photoresist may be deposited over the first semiconductor layer 103 and may be exposed to radiation (e.g., UV radiation) through a photolithographic mask (i.e., a photomask) to transfer the mask pattern to the photoresist. A developing process may be used to remove select portions of the photoresist, leaving behind the mask pattern. An etching process may then be performed through the patterned photoresist to remove select portions of first semiconductor layer 103 to define the features of the first optical component(s) 105.

In some embodiments, additional material may be deposited over the etched first semiconductor layer 103. The additional material may include material having a different index of refraction than that of the first semiconductor layer 103. The different indices of refraction may provide confinement and propagation of optical signals (i.e., photons) within the first semiconductor layer 103, where the material with the relatively higher index of refraction may function as the “core” material and the material with the lower index of refraction may surround the core material and function as a “cladding” material that may confine and enable the optical signals to propagate within the core material via total internal reflection. In one non-limiting embodiment, the semiconductor material (e.g., silicon) of the first semiconductor layer 103 may provide a core material for the various optical components 105 and a suitable dielectric material, such as silicon oxide (SiO₂), silicon nitride (SiN), alumina (Al₂O₃), silica glass (e.g., fluorine-doped silica), a polymer-based dielectric material (e.g., silicone, a fluoropolymer material, etc.), having a lower index of refraction may be deposited over the etched features of the first semiconductor layer 103 to provide a cladding material. In some embodiments, additional material(s), such as semiconductor materials, metal materials, and/or dielectric materials, may also be deposited over the etched first semiconductor layer 103 and/or the cladding material, and may be optionally patterned as described above to fabricate the first optical components 105 of the first IC photonic structure 100. In some embodiments, one or more implantation processes may be performed to implant dopants (i.e., p-type and/or n-type dopants) in select regions of the first semiconductor layer 103. The doped region(s) of the first semiconductor layer 103 may form p-n junctions or p-i-n junctions within the first semiconductor layer 103 that may enable formation of electro-optical components, such as optical modulators, sensors, light sources, etc. All or some of the above processes may be repeated as necessary to fabricate the first optical components 105 within the first semiconductor layer 103. The first semiconductor layer 103 including the first optical components 105 may have a planar upper surface.

Referring again to FIG. 1A, the first interconnect structure 106 of the first IC photonic structure 100 may include a dielectric material 107 formed over the upper surface of the first semiconductor layer 103 and conductive interconnect structures 108 formed within the dielectric material 107. In various embodiments, the dielectric material 107 of the first interconnect structure 106 may include any suitable dielectric material, such as silicon oxide, silicon nitride, silicon carbide, silicon oxynitride, silicon carbon nitride, a low-K dielectric material, and extremely low-K (ELK) dielectric material, undoped silicon glass (USG), fluorosilicate glass (FSG), phosphor-silicate glass (PSG), a polymer-based dielectric material (e.g., polyimide (PI), epoxy resin, polybenzoxazole (PBO)), etc., including combinations thereof. Other suitable materials for the dielectric material 107 are within the contemplated scope of disclosure. The dielectric material 107 may be deposited over the upper surface of the first semiconductor layer 103 using any suitable deposition process. Herein, “suitable deposition processes” may include a chemical vapor deposition (CVD) process, a physical vapor deposition (PVD) process, an atomic layer deposition (ALD) process, a high density plasma CVD (HDPCVD) process, a low pressure CVD process, a metalorganic CVD (MOCVD) process, a plasma enhanced CVD (PECVD) process, a sputtering process, laser ablation, or the like, including various combinations thereof.

The conductive interconnect structures 108 may include metal features, such as metal lines and metal vias, embedded within the dielectric material 107 of the first interconnect structure 106. The conductive interconnect structures 108 may include any suitable metals, metal alloys, and/or other metal-containing compounds (e.g., Cu, Al, Ni, Mo, Co, Ru, Ti, Ta, W, TiN, TaN, WN, etc.). Other suitable electrically conductive materials are within the contemplated scope of disclosure. In one non-limiting example, the first interconnect structure 106 may be formed by sequentially depositing layers of the dielectric material 107 over the first semiconductor layer 103. Each of the layers of the dielectric material 107 may be photolithographically patterned and etched as described above to form open regions (e.g., trenches and/or via openings). A metal material may be deposited with the open regions via a suitable deposition process, such as PVD, sputtering, CVD, ALD, PECVD, electrochemical deposition (e.g., electroplating), or combinations thereof, to form conductive interconnect features 108 (e.g., metal lines and vias) within each successive layer of dielectric material 107. In this manner, the first interconnect structure 106 may be built layer-by-layer over the upper surface of the first semiconductor layer 103.

In various embodiments, the conductive interconnect features 108 of the first interconnect structure 106 may be electrically coupled to at least some of the first optical components 105 of the first semiconductor layer 103. That is, the conductive interconnect features 108 of the first interconnect structure 106 may be configured to transmit or receive electrical signals (e.g., current and/or voltage signals) to and/or from the first optical components 105 formed in the first semiconductor layer 103. In various embodiments, the first interconnect structure 106 may additionally include one or more first bonding pads 109 within the dielectric material 107. Conductive interconnect features 108 may electrically couple each of the first bonding pads 109 to underlying first optical component(s) 105 in the first semiconductor layer 103.

In some embodiments, the first IC photonic structure 100 may include a wafer. The wafer may include multiple instances of first optical components 105 formed in a first semiconductor wafer 103 and electrically coupled to conductive interconnect features 108 of a first interconnect structure 106 as shown FIG. 1A, where each of the instances may be located on a common support substrate 110. A dicing process may be subsequently performed to separate individual instances from the wafer to provide individual first IC photonic dies. In other embodiments, the first IC photonic structure 100 may include a first IC photonic die that has been separated from a wafer (e.g., via an above-described dicing process).

FIG. 1B is a vertical cross-sectional view of a second integrated circuit (IC) photonic structure 200 according to various embodiments of the present disclosure. Referring to FIG. 1B, in various embodiments, the second IC photonic structure 100 may include a second insulator layer 201, a second semiconductor layer 203 over the second insulator layer 201, and a second interconnect structure 206 over the second semiconductor layer 203. A second support substrate 210 may provide mechanical support for the second IC photonic structure 200. The second IC photonic structure 200 may be equivalent to the first IC photonic structure 100 described above. Thus, repeated discussion of like elements is omitted for brevity. Second optical components 205 located within the second semiconductor layer 203 may be the same as or may be different than the first optical components 105 located within the first semiconductor layer 103. In some embodiments, the second IC photonic structure 200 may include different optical components 205 and/or may have a different arrangement of optical components 205 than the first IC photonic structure 100. In various embodiments, the first IC photonic structure 100 and the second IC photonic structure 200 may be configured to perform different functions and/or different processing operations on optical signals.

The second interconnect structure 206 may include bonding pads 209 and conductive interconnect structures 208 formed within dielectric material 207, wherein the conductive interconnect structures 208 may electrically couple the bonding pads 209 to at least a portion of the second optical components 205 in the second semiconductor layer 203. As in the case of the first IC photonic structure 100, the second IC photonic structure 200 may include a portion of a wafer that may be subsequently subjected to a dicing process to provide an individual second IC photonic die, or the second IC photonic structure 200 may be a second IC photonic die that has that has been separated from a wafer (e.g., via an above-described dicing process).

FIG. 1C is a vertical cross-sectional view of a vertical coupling interlayer (VCIL) structure 300 according to various embodiments of the present disclosure. Referring to FIG. 1C, the VCIL structure 300 may include a third support substrate 310, a dielectric material 303 over the third support substrate 310, and third optical components 305 located within the dielectric material 303. The third support substrate 310 may include a suitable substrate material, such as a semiconductor material (e.g., silicon), although it will be understood that other substrate materials are within the contemplated scope of disclosure. The dielectric material 303 may include a suitable dielectric material, such as silicon oxide (SiO₂), silicon nitride (SiN), alumina (Al₂O₃), silica glass (e.g., fluorine-doped silica), a polymer-based dielectric material (e.g., silicone, a fluoropolymer material, etc.), and the like. Other suitable materials for the dielectric material 303 are within the contemplated scope of disclosure. The dielectric material 303 may be deposited over the third support substrate 310 via a suitable deposition process as described above.

In various embodiments, the dielectric material 303 of the VCIL structure 300 may function as a cladding material for the third optical components 305. Thus, the dielectric material 303 of the VCIL structure 300 may also be referred to as a “cladding material.” The third optical components 305 may be formed within the dielectric material 303 and in some embodiments may be surrounded on all sides by the dielectric material 303. The third optical components 305 may include material(s) having a higher index of refraction than the dielectric material 303. Thus, the third optical components 305 may include a “core material” that is surrounded by a cladding material (i.e., dielectric material 303) having a relatively lower refractive index. This may facilitate confinement and propagation of optical signals (i.e., photons) within the third optical components 305 of the VCIL structure 300. Suitable core materials for the third optical components 305 may include, for example, a semiconductor material (e.g., silicon (Si), gallium arsenide (GaAs), etc.), silica glass, doped silica glass, a polymer-based material (e.g., polycarbonate, PMMA, etc.), silicon nitride, etc., including combinations thereof. In one non-limiting embodiment, the third optical components 305 of the VCIL structure 300 may include silicon or silicon nitride, and the surrounding dielectric material 303 of the VCIL structure 300 may include an oxide material (e.g., silicon oxide).

In various embodiments, the third optical components 305 of the VCIL structure 300 may include passive optical components. As used herein, a passive optical component includes an optical component in which the functionality of the optical component does not require an electrical input (e.g., a current or voltage signal). Examples of passive optical components may include, without limitation, waveguides, gratings, mirrors, lenses, resonators (e.g., ring resonators, Fabry-Perot cavities), interferometers (e.g., passive MZIs), and the like. Other suitable passive optical components are within the contemplated scope of disclosure.

In some embodiments, the third optical components 305 may be fabricated by depositing a continuous layer of the dielectric material 303 over the third support substrate 310, patterning the continuous layer of the dielectric material 303 using photolithographic and etching processes as described above to form one or more openings in the dielectric material 303, where each opening may be in the shape of a third optical component 305 to be subsequently formed. A core material as described above may be deposited over the dielectric material 303 and within the openings in the dielectric material 303 using a suitable deposition process. A planarization process, such as a chemical mechanical planarization (CMP) process, may be used to remove excess core material from over the upper surface of the dielectric material 303 and provide discrete third optical components 305 within the dielectric material 303. The dielectric material 303 may surround the third optical components 305 on the bottom surfaces and side surfaces of the third optical components 305. Additional dielectric material 303 may be deposited over the third optical components 305 such that the additional dielectric material 303 may surround the third optical components 305 on the upper surfaces of the third optical components 305.

In some embodiments, the third optical components 305 may be fabricated by depositing a continuous layer of the dielectric material 303 over the third support substrate 310 and depositing a continuous layer of core material over the continuous layer of dielectric material 303. The continuous layer of core material may be patterned using photolithographic and etching processes as described above to provide discrete third optical components 305 over the continuous layer of the dielectric material 303. Additional dielectric material 303 may be deposited over the continuous layer of dielectric material 303 and the third optical components 305 located thereon such that the third optical components 305 may be surrounded by the dielectric material 303.

In some embodiments, multiple third optical components 305 may be formed vertically separated from one another. Referring to FIG. 1C for example, one or more third optical components 305 may be formed in a first level L1 of the VCIL structure 300 (i.e., within a first horizontal plane of the VCIL structure 300) and one or more third optical components 305 may be formed in a second level L2 of the VCIL structure 300 (i.e., in a second horizontal plane that is vertically offset from the first horizontal plane). One or more third optical components 305 located in the second level L2 may at least partially vertically overlap one or more third optical components 305 located in the first level L1. Dielectric material 303 may be located between the vertically overlapping portions of the third optical components 305 in the first level L1 and the second level L2. The third optical components 305 in each of the levels L1, L2 of the VCIL structure 300 may be formed using the process(es) described above. Although the embodiment shown in FIG. 1C illustrates two different levels L1 and L2 of the third optical components 305, it will be understood that a VCIL structure 300 may have more than two levels in various embodiments. In addition, VCIL structures 300 according to various embodiments may include a single level in which all of the third optical components 305 may be located in the same horizontal plane.

Referring again to FIG. 1C, in some embodiments, the VCIL structure 300 may include an optical transmission region 307 that includes one or more third optical components 305 and an optical isolation region 309 that does not include any third optical components 305. The optical isolation region 309 may extend continuously between a first surface 306 of the dielectric material 303 (i.e., adjacent to the third support substrate 310) and a second surface 308 of the dielectric material 303 (i.e., opposite the third support substrate 310). In some embodiments, a thickness of the dielectric material 303 of the VCIL 300 between the first surface 306 and the second surface 308 may be between about 50 nm and about 250 nm, although greater and lesser thicknesses may also be utilized.

As in the case of the first IC photonic structure 100 and the second IC photonic structure 200, the VCIL structure 300 may be a wafer including multiple instances of third optical components 305 formed within a dielectric material 303 located on a common substrate 310. The wafer may include multiple dies that may be subsequently singulated or diced or may be an individual die including a single instance of the third optical components 305 formed within a dielectric material 303 on a supporting substrate 310.

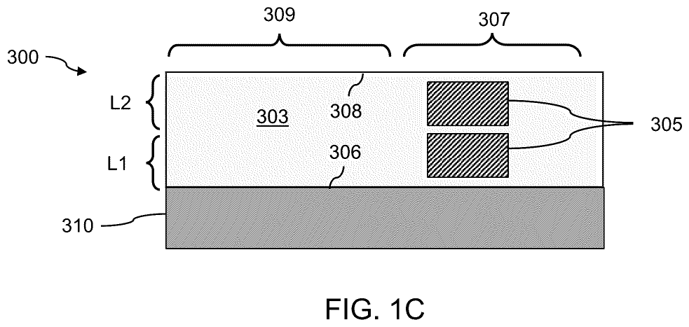

FIG. 2 is a vertical cross-sectional view illustrating the second IC photonic structure 200 bonded to the VCIL structure 300 according to various embodiments of the present disclosure. Referring to FIG. 2, a bonding process may be used to bond the second IC photonic structure 200 to the VCIL structure 300. In some embodiments, the second support substrate 210 of the second IC photonic structure 200 (if present) may be removed from the second IC photonic structure 200 via a suitable process. In some embodiments, the second support substrate 210 may be removed via a polishing or grinding process. Alternatively, the second support substrate 210 may be mechanically separated from the remainder of the second IC photonic structure 200, such in embodiments in which the second support substrate 210 is temporarily attached to the remainder of the second IC photonic structure 200 (e.g., via a releasable adhesive). Following the removal of second support substrate 210 from the remainder of the second IC photonic structure 200, the lower surface of the second insulator layer 201 of the second IC photonic structure 200 may be exposed.

In various embodiments, the second IC photonic structure 200 may be bonded to the VCIL structure 300 using a direct bonding process, such as a fusion bonding process. Other suitable bonding processes for bonding the second IC photonic structure 200 and the VCIL structure 300 may also be utilized. In various embodiments, a direct bonding process may be used to bond the second surface 308 of the dielectric material 303 of the VCIL structure 300 to the lower surface of the second insulator layer 201 of the second IC photonic structure 200 and thereby mechanically couple the VCIL structure 300 and the second IC photonic structure 200. In various embodiments, the second surface 308 of the dielectric material 303 of the VCIL structure 300 and the lower surface of the second insulator layer 201 of the second IC photonic structure 200 may be cleaned and optionally subjected to a pre-treatment process (e.g., a plasma treatment process) to promote surface activation. To perform the bonding process, the second IC photonic structure 200 may be aligned over the VCIL structure 300 using a suitable positioning apparatus, such as a bond head or pick-and-place (PNP) machine, and alignment marks. The second IC photonic structure 200 and the VCIL structure 300 may be brought together such that the lower surface of the second insulator layer 201 of the second IC photonic structure 200 contacts the second surface 308 of the dielectric material 303 of the VCIL structure 300. Bringing the lower surface of the second insulator layer 201 of the second IC photonic structure 200 into contact with the second surface 308 of the dielectric material 303 of the VCIL structure 300 may result in a pre-bonding process in which chemical bonds (e.g., hydrogen bridge bonds) may form at the planar interface between the second insulator layer 201 of the second IC photonic structure 200 and the second surface 308 of the dielectric material 303 of the VCIL structure 300. In some embodiments, the pre-bonding process may be performed at ambient temperature (e.g., ~20°C). In other embodiments, the pre-bonding process may be performed at an elevated temperature. In some embodiments, a compressive force may be applied to the second IC photonic structure 200 and the VCIL structure 300 during the pre-bonding process. In other embodiments, no compressive force may be applied during the pre-bonding process.

In some embodiments, an annealing process may be performed to complete the bonding of the second insulator layer 201 of the second IC photonic structure 200 and the second surface 308 of the dielectric material 303 of the VCIL structure 300. The annealing process may be performed at an elevated temperature, such as 100° C. or more, such as between about 150° C. and about 350° C., although lower and higher temperatures may also be utilized. In some embodiments, a compressive force may be applied to the second IC photonic structure 200 and the VCIL structure 300 during the annealing process. In other embodiments, no compressive force may be applied during the annealing process.

Following the bonding process, the second IC photonic structure 200 may be mechanically bonded to the VCIL structure 300 at a bonding interface 320. In various embodiments, the second IC photonic structure 200 may be bonded to the VCIL structure 300 such a portion of at least one second optical component 205 of the second IC photonic structure 200 (e.g., second optical component 205a shown in FIG. 2) may vertically overlap with one or more third optical components 305 of the VCIL structure 300. In some embodiments, other second optical components 205 of the second IC photonic structure 200 (e.g., second optical component 205b shown in FIG. 2) may not vertically overlap with third optical component 305 of the VCIL structure 300 and may be located adjacent to an isolation region 309 of the VCIL structure 300.

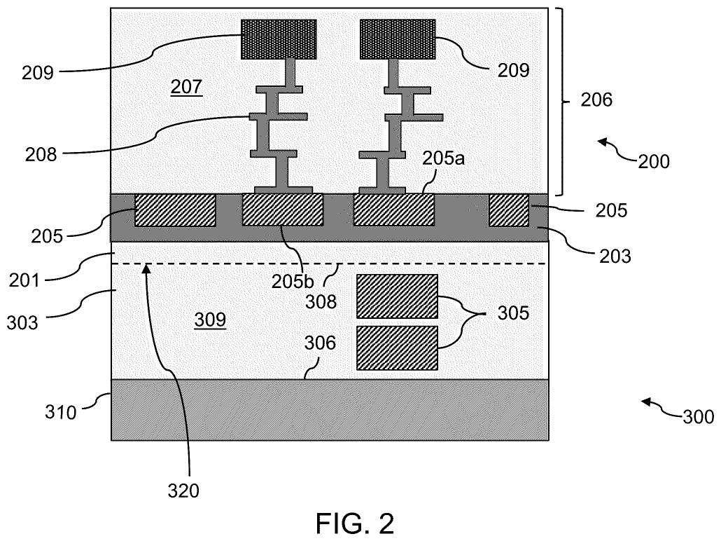

FIG. 3 is a vertical cross-sectional view illustrating the VCIL structure 300 bonded to the first IC photonic structure 100 to form a bonded photonic structure 350 according to various embodiments of the present disclosure. Referring to FIG. 3, in some embodiments, the second IC photonic structure 200 and the VCIL structure 300 shown in FIG. 2 may be inverted (i.e., flipped over) relative to the orientation shown in FIG. 2. In some embodiments, the third support substrate 310 may be removed from the VCIL structure 300 via a suitable process, such as via a polishing or grinding process. Following the removal of the third support substrate 310, the first surface 306 of the dielectric material 303 of the VCIL structure 300 may be exposed.

Referring again to FIG. 3, the first IC photonic structure 100 may be bonded to the VCIL structure 300 via process steps similar or identical to those described above with reference to FIG. 2. In particular, the first support substrate 110 of the first IC photonic structure 100 (if present) may be removed via a suitable process as described above to expose the lower surface of the first insulator layer 101 of the first IC photonic structure 100.

A bonding process may be used to bond the first IC photonic structure 100 to the VCIL structure 300. In some embodiments, a direct bonding process, such as a fusion bonding process, may be used to bond the first surface 306 of the dielectric material 303 of the VCIL structure 300 to the lower surface of the first insulator layer 101 of the first IC photonic structure 100. The first surface 306 of the dielectric material 303 of the VCIL structure 300 and the lower surface of the first insulator layer 101 of the first IC photonic structure 100 may be cleaned and optionally pre-treated (e.g., subjected to a plasma treatment process) as described above. The first IC photonic structure 100 may be aligned over the VCIL structure 300 and the first IC photonic structure 100 and the VCIL structure 300 may be brought together such that the lower surface of the first insulator layer 101 of the first IC photonic structure 100 contacts the first surface 306 of the dielectric material 303 of the VCIL structure 300. This may result in a pre-bonding process in which chemical bonds (e.g., hydrogen bridge bonds) may form at the planar interface between the first insulator layer 101 of the first IC photonic structure 100 and the first surface 306 of the dielectric material 303 of the VCIL structure 300. The pre-bonding process may be performed at ambient temperature or at an elevated temperature. The pre-bonding process may be performed with or without a compressive force being applied to the first IC photonic structure 100 and the VCIL structure 300.

An annealing process may be performed to complete the bonding of the first insulator layer 101 of the first IC photonic structure 100 and the first surface 306 of the dielectric material 303 of the VCIL structure 300. The annealing process may be performed at an elevated temperature, such as 100° C. or more, such as between about 150° C. and about 350° C., although lower and higher temperatures may also be utilized. The annealing process may be performed with or without a compressive force being applied to the first IC photonic structure 100 and the VCIL structure 300.

While the process above describes the second IC photonic structure 200 bonded to the VCIL structure 300 and then the 1st I see photonic structure 100 bonded to the VCIL structure 300, it should be clear to one of ordinary skill that the order of bonding maybe reversed or may be performed simultaneously.

Following the bonding process, a bonded photonic structure 350 may include the first IC photonic structure 100 bonded to the VCIL structure 300 at a first bonding interface 315 and the second IC photonic structure 200 bonded to the VCIL structure 300 at a second bonding interface 320. In various embodiments, the first IC photonic structure 100 may be bonded to the VCIL structure 300 such a portion of at least one first optical component 105 of the first IC photonic structure 100 (e.g., first optical component 105a shown in FIG. 3) may vertically overlap with one or more third optical components 305 of the VCIL structure 300. In some embodiments, other first optical components 105 of the first IC photonic structure 100 (e.g., first optical component 105b shown in FIG. 3) may not vertically overlap with a third optical component 305 of the VCIL structure 300 and may be located adjacent to an isolation region 309 of the VCIL structure 300. In some embodiments, one or more first optical components 105 (e.g., first optical component 105b) may vertically overlap with a second optical component 205 (e.g., second optical component 205b) and may be vertically separated from the second optical component 205 by the isolation region 309 of the VCIL structure 300.

In various embodiments, the first bonding interface 315 may be located between one or more first optical components 105 of the first IC photonic structure 100 and one or more third optical components 305 of the VCIL structure 300, and the second bonding interface 320 may be located between one or more second optical components 205 of the second IC photonic structure 200 and one or more third optical components 305 of the VCIL structure 300. In some embodiments, the first insulator layer 101 may be located between the one or more first optical components 105 of the first IC photonic structure 100 and the first bonding interface 315 of the bonded photonic structure 350. The second insulator layer 201 may be located between the one or more second optical components 205 of the second IC photonic structure 200 and the second bonding interface 320 of the bonded photonic structure 350.

In various embodiments, portions of the dielectric layer 303 of the VCIL structure 300 may be located between the third optical component(s) 305 of the VCIL structure 300 and the first bonding interface 315 and the second bonding interface 320 of the bonded photonic structure 350. Although in the embodiment shown in FIG. 3, the third support substrate 310 is removed from the VCIL structure 300 prior to bonding the VCIL structure 300 to the first IC photonic structure 100, in other embodiments, the third support substrate 310 may not be removed from the VCIL structure 300. In some embodiments, depending on optical transmission characteristics in the bonded photonic structure 350, all or a portion of the third support substrate 310 may be present in the bonded photonic structure 350 (i.e., located between the third optical component(s) 305 of the VCIL structure 300 and the first bonding interface 315). This may be the case, for example, where the third support substrate 310 includes an SOI oxide material.

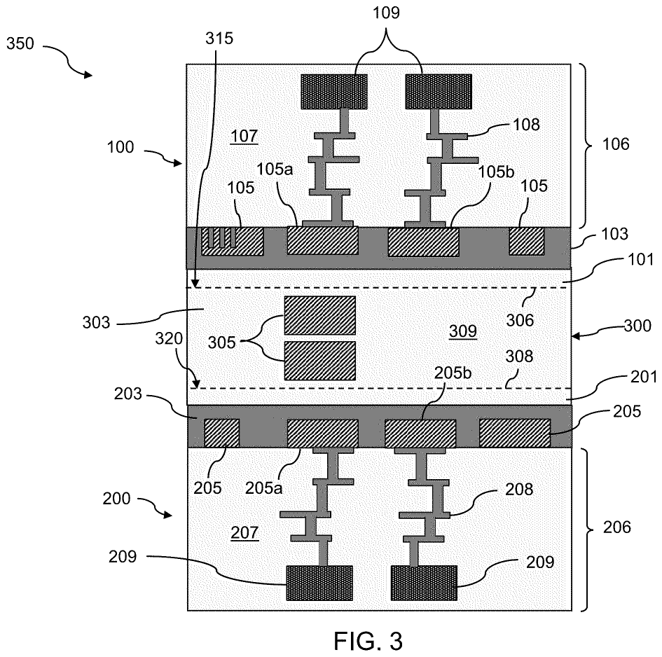

FIG. 4 is a vertical cross-sectional view of a bonded photonic die 450 including a first IC electronic die 401 bonded to a first IC photonic structure 100 and a second IC electronic die 403 bonded to a second IC photonic structure 200 and a VLIC structure 300 located between the first IC photonic structure 100 and the second IC photonic structure 200 according to various embodiments of the present disclosure. Referring to FIG. 4, the first IC electronic die 401 and the second IC electronic die 403 each bonded to a bonded photonic structure 350 as shown in FIG. 3. The first IC electronic die 401 and the second IC electronic die 403 may each include a plurality of electronic circuit components (e.g., transistors, diodes, resistors, capacitors, etc.) integrated on a single die or “chip.” The first IC electronic die 401 and the second IC electronic die 403 may be configured to receive, transmit, and/or perform processing operations on electronic signals. In various embodiments, the first IC electronic die 401 and the second IC electronic die 403 may each be configured to be operatively coupled to an IC photonic die structure such that optical signals at the IC photonic structure may be converted to electrical signals that may be further processed and/or transmitted by the IC electronic die 401, 403. For example, optical signals received at one or more detectors (e.g., photodetectors) of an IC photonic structure may be converted to electrical signals that may be read-out and optionally further processed (e.g., amplified, converted from analog signals to digital signals, etc.) by the associated first IC electronic die 401 and the second IC electronic die 403. The first IC electronic die 401 and the second IC electronic die 403 may then transmit the electronic signals to one or more other components of a semiconductor package. Similarly, in some embodiments, each of the first IC electronic die 401 and the second IC electronic die 403 may include circuitry (e.g., driver circuitry) that is configured to provide electronic signals to an associated IC photonic structure that may be converted to optical signals (e.g., via an optical modulator of the IC photonic structure) that may be transmitted via one or more optical waveguides to a photonic component, such as another IC photonic structure, that may be located on or external to the semiconductor package. The first IC electronic die 401 and the second IC electronic die 403 may thus be considered as providing interfaces between the electronic and photonic components of a semiconductor package.

Referring again to FIG. 4, in various embodiments, a bonding process may be used to bond bonding features on the first IC photonic structure 100 to corresponding bonding features on the first IC electronic die 401. In some embodiments, a direct bonding technique, such as metal-to-metal (M-M) and dielectric-to-dielectric (D-D) bonding technique, may be used to bond the first IC photonic structure 100 to the first IC electronic die 401. In various embodiments, bonding layers 351 may be formed on respective surfaces of the first IC photonic structure 100 and the first IC electronic die 401. In the embodiment shown in FIG. 4, a bonding layer 351 may be formed on the upper surface of the first IC photonic structure 100. The bonding layer 351 may include a dielectric material 353. The dielectric material 353 may include, for example, one or more of silicon oxide, silicon nitride, silicon carbide, silicon carbon nitride, silicon oxynitride, a dielectric polymer material, or the like. Other suitable dielectric materials are within the contemplated scope of disclosure. The dielectric material 353 may be deposited using a suitable deposition process as described above. The bonding layer 351 may also include a plurality of metal bonding pads 355 formed within the dielectric material 353. The metal bonding pads 355 may be formed by forming a plurality of openings in the dielectric material 353 and depositing a metal material within the openings, such as via a damascene or dual-damascene process. The metal material may include copper (Cu), tungsten (W), aluminum (Al), and the like. The metal material may be deposited using a suitable deposition process as described above. At least some of the metal bonding pads 355 may be electrically coupled to an underlying first bonding pad 109 of the first IC photonic structure 100 by a conductive via 357.

A similar or identical bonding layer 351 including metal bonding pads 355 embedded in a dielectric material 353 may be formed over the lower surface of the first IC electronic die 401.

Referring yet again to FIG. 4, a bonding process may be performed to bond the respective bonding layers 351 on the first IC electronic die 401 and the first IC photonic structure 100, and thereby mechanically and electrically couple the first IC electronic die 401 to the first IC photonic structure 100. In various embodiments, bonding layers 351 may be bonded via a metal-to-metal (M-M) and dielectric-to-dielectric (D-D) direct bonding technique. In some embodiments, the surfaces of the respective bonding layers 351 may be cleaned and pre-treated (e.g., subjected to a plasma treatment). The first IC electronic die 401 may be aligned over the first IC photonic structure 100 using a suitable positioning apparatus, such as a bond head. The first IC electronic die 401 may be aligned over the first IC photonic structure 100 such that metal bonding pads 355 of the bonding pad 351 on the first IC electronic die 401 are aligned with corresponding metal bonding pads 355 of the bonding layer 351 on the first IC photonic structure 100. The first IC electronic die 401 and the first IC photonic structure 100 may be brought together such that the respective bonding layers 351 contact one another. This may result in a pre-bonding process in which chemical bonds (e.g., hydrogen bridge bonds) may form at the planar interface between the dielectric material 353 of the respective bonding layers 351. The pre-bonding process may be performed at ambient temperature or at an elevated temperature. The pre-bonding process may be performed with or without a compressive force being applied to the first IC electronic die 401 and the first IC photonic structure 100.

In some embodiments, an annealing process may be performed to complete the bonding of the corresponding pairs of metal bonding pads 355 of the respective bonding layers 351 on the first IC electronic die 401 and the first IC photonic structure 100. The annealing process may be performed at an elevated temperature, such as 100° C. or more, such as between about 150° C. and about 350° C., although lower and higher temperatures may also be utilized. The annealing process may be performed with or without a compressive force being applied to the first IC electronic die 401 and the first IC photonic structure 100.

Following the bonding process, the first IC electronic die 401 may be mechanically and electrically coupled to the first IC photonic structure 100 at a bonding interface 358. Electrical signals may be transmitted between the first IC electronic die 401 and the first IC photonic structure 100 via the bonding pads 355 of the bonding layers 351. The first IC electronic die 401 may therefore be electrically coupled to one or more first optical components 105 of the first IC photonic structure 100 by the vias 357, the bonding pads 109, and the conductive interconnect structures 108 of the first IC photonic structure 100.

An alternative bonding process may be used to bond bonding features on the second IC photonic structure 200 to corresponding bonding features on the second IC electronic die 403. Referring to FIG. 4, bonding layers 351 including metal bonding pads 355 formed within a dielectric material 353 may be formed over the lower surface of the second IC photonic structure 200 and over the upper surface of the second IC electronic die 401. A metal-to-metal (M-M) and dielectric-to-dielectric (D-D) direct bonding process as described above may be performed to electrically and mechanically couple the second IC electronic die 403 to the second IC photonic structure 200 at a bonding interface 358.

Although FIG. 4 illustrates the first IC electronic die 401 bonded to the first IC photonic structure 100 and the second IC electronic die 403 bonded to the second IC photonic structure 200 via metal-to-metal (M-M) and dielectric-to-dielectric (D-D) direct bonding processes, it will be understood that other bonding processes, such as a microbump bonding process, may be used to bond the first IC electronic die 401 and the first IC photonic structure 100 and/or to bond the second IC electronic die 403 and the second IC photonic structure 200.

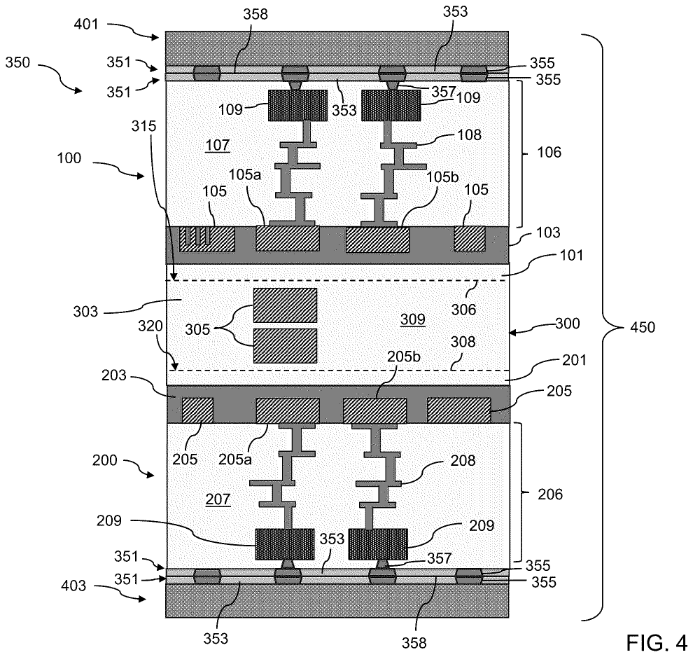

FIG. 5 is a is a vertical cross-sectional view of a bonded photonic die 450 according to another embodiment of the present disclosure. The bonded photonic die 450 of FIG. 5 is similar to the bonded photonic die 450 of FIG. 4. The bonded photonic die 450 of FIG. 5 differs from the bonded photonic die 450 of FIG. 4 in that a first IC electronic die 401 is bonded to the first IC photonic structure 100, but no IC electronic die is bonded to the second IC photonic structure 200.

In various embodiments of a bonded photonic die 450 such as shown in FIGS. 4 and 5, the VCIL structure 300 may enable routing of optical signals between the first IC photonic structure 100 and the second IC photonic structure 200. By providing a bonded photonic die 450 having a vertically stacked, three-dimensional structure including the VCIL structure 300 located between the first IC photonic structure 100 and the second IC photonic structure 200, optical signals in the bonded photonic die 450 may be transmitted along a vertical direction between the first IC photonic structure 100 and the second IC photonic structure 200 using the third optical components 305 in the VCIL structure 300. This contrasts with related IC photonic chip designs in which the various optical components are located within the same horizontal plane. Thus, a chip having the equivalent optical components and/or functionality as the first IC photonic structure 100 and the second IC photonic structure 200 would require a much larger chip area compared to the bonded photonic die 450 of FIGS. 4 and 5. In addition, because all of the optical signals in such related devices are transmitted in a lateral direction, the signal routing design may become extremely complex, which may lead to low coupling efficiency, excessive cross-talk between different optical paths, and high insertion loss.

In contrast, a bonded photonic die 450 having a vertically stacked, three-dimensional design including a VCIL structure 300 in accordance with various embodiments of the present disclosure may enable a more compact design with greater flexibility in the routing of optical signals. For example, signals transmitted from a first optical component 105 on the first IC photonic structure 100 to a second optical component 205 on the second IC photonic structure 200 may be routed in a variety of different ways. One optical transmission pathway may include a vertical coupling between the first optical component 105 and a third optical component 305 of the VCIL structure 300, and a vertical coupling between the third optical component 105 of the VCIL structure 300 and the target second optical component 205 on the second IC photonic structure 200. Alternatively, the optical transmission pathway may include a vertical coupling between the first optical component 105 and a third optical component 105 of the VCIL structure 300, a lateral transmission and/or lateral coupling between one or more third optical components 305 in the VCIL structure 300, and a vertical coupling between a third optical component 305 of the VCIL structure 300 and the target second optical component 205 on the second IC photonic structure 200.

Various other optical transmission pathways may also be utilized. For example, in embodiments in which the VCIL structure 300 includes multiple levels of third optical components 305 (e.g., L1 and L2 as shown in FIG. 1C), optical transmission within the VCIL structure 300 may include both vertical coupling between different third optical components 305 located within different levels L1, L2 as well as lateral transmission and/or lateral coupling between one or more third optical components 305 located in the same level L1, L2. In some embodiments, signals transmitted between different optical components located on the same IC photonic structure (e.g., the first IC photonic structure 100 or the second IC photonic structure 200) may be routed in part through the VCIL structure 300, which may help to conserve space and/or minimize cross-talk or other causes of optical loss in the IC photonic structure. In addition, in various embodiments one or more optical isolation regions 309 of the VCIL structure 300 as described above may provide optical isolation between different optical signal pathways located on the first IC photonic structure 100 and the second IC photonic structure 200. This may mitigate against signal cross-talk and reduce optical losses.

In various embodiments, vertical coupling of optical signals between third optical components 105 of the VCIL structure 300 and a first optical component 105 of the first IC photonic structure 100 may occur across the first bonding interface 315, and vertical coupling between third optical components 105 of the VCIL structure 300 and a second optical component 205 of the second IC photonic structure 200 may occur across the second bonding interface 320. There are a number of techniques in which such vertical coupling of optical signals may be achieved, such as using diffractive coupling (e.g., a grating), an inverted taper vertical coupler, evanescent coupling, adiabatic coupling, direct butt coupling, and the like.

In some embodiments, optical signals may be coupled between a third optical component 105 of the VCIL structure 300 and a first optical component 105 of the first IC photonic structure 100 and/or between a third optical component 105 of the VCIL structure 300 and a second optical component 205 of the second IC photonic structure 200 by wavelength-selective vertical coupling. In some embodiments, a resonant structure, such as a ring or disk resonator, may be used to selectively couple optical signals along a vertical direction from a first waveguide located in a first horizontal plane to a second waveguide located in a second horizontal plane based on the resonant wavelength of the structure. The resonator may be configured to couple the signals between the different waveguides only at specific wavelengths where the light resonates within the resonator.

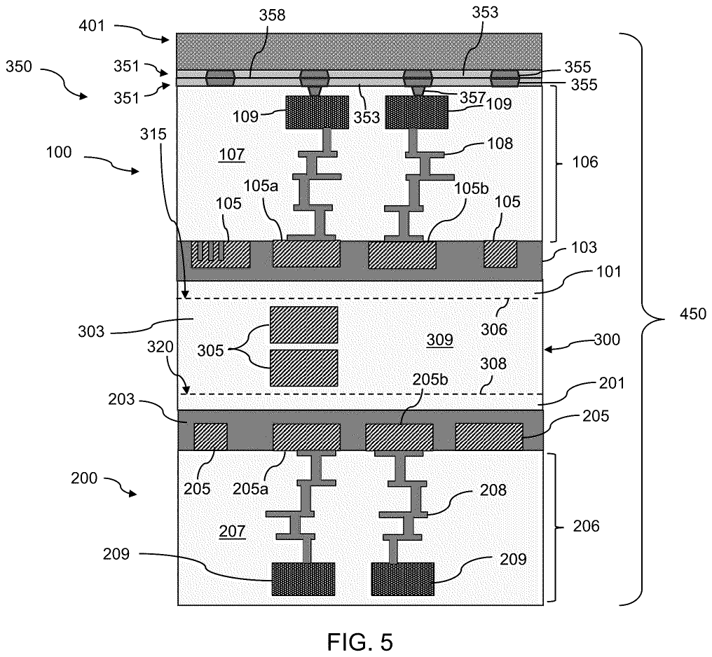

FIGS. 6A and 6B are side perspective views of a portion of a bonded photonic die schematically illustrating the routing of optical signals using wavelength-selective vertical coupling according to various embodiments of the present disclosure. Referring to FIGS. 6A and 6B, a VCIL structure 300 is shown bonded between a first IC photonic structure 100 and a second IC photonic structure 200 as described above. The first IC photonic structure 100 includes a first micro-resonator device 601 laterally coupled to a first waveguide 603. The second IC photonic structure 200 includes a second micro-resonator device 607 laterally coupled to a second waveguide 609. The VCIL structure 300 may include a third waveguide 605 located between the first micro-resonator device 601 and the second micro-resonator device 607. A coupling ratio may be defined as the percentage of optical power that is transferred from one optical component to another in an optical device. In various embodiments, the coupling ratio between each of first and second micro-resonator devices 601, 607 and the third waveguide 605 of the VCIL structure 300 may be dependent on both the wavelength of the optical signals and the “effective coupling length” between the respective micro-resonator devices 601, 607 and the third waveguide 605. The effective coupling length for a given wavelength may be determined by the geometry (e.g., resonance characteristics) of the micro-resonator devices 601, 607, the refractive index of the materials between the micro-resonator devices 601, 607 and the third waveguide 605, and the space (i.e., S2 in FIG. 6B) between the respective micro-resonator devices 601, 607 and the third waveguide 605. In various embodiments, these characteristics (i.e., the geometries of the micro-resonator devices 601, 607, the refractive index of the material(s) between the micro-resonator devices 601, 607 and the third waveguide 605, and the spacing between the micro-resonator devices 601, 607 and the third waveguide 605) may be controlled to provide a high coupling ratio between the micro-resonator devices 601, 607 and the third waveguide 605 for a particular wavelength or range of wavelengths. For other wavelengths, the coupling ratio between the micro-resonator devices 601, 607 and the third waveguide 605 may be much lower. This may provide wavelength-selective vertical coupling between the micro-resonator devices 601, 607 and the third waveguide 605.

An example of wavelength-selective routing of optical signals in a bonded photonic die according to various embodiments is shown in FIGS. 6A and 6B. FIG. 6A illustrates an input signal having a first wavelength entering the second micro-resonator device 607 of the second IC photonic structure 200. The wavelength of the input signal in FIG. 6A does not match the coupling condition of the first and second micro-resonator devices 601 and 607, thus the optical signal entering the second micro-resonator device 607 does not vertically couple from the second micro-resonator device 607 to the third waveguide 605 and then to the first micro-resonator device 607, but instead is laterally coupled from the second micro-resonator device to the second waveguide 209. The signal may then propagate through the second waveguide 209 in the second IC photonic structure 200.

FIG. 6B illustrates an example where the wavelength of the input signal does match the coupling condition of the first and second micro-resonator devices 601 and 607. In this case, the optical signal entering the second micro-resonator device 607 is vertically coupled from the second micro-resonator device 607 to the third waveguide 605 and is then vertically coupled from the third waveguide 605 to the first micro-resonator device 601. The coupling ratios between the second micro-resonator device 607 and the third waveguide 605 and between the first micro-resonator device 601 and the third waveguide 605 may both be very high, resulting in minimal insertion loss of the optical signals transmitted between the second IC photonic structure 200 and the first IC photonic structure 100. The signal may then be laterally coupled from the first micro-resonator device 201 into the first waveguide 603. The signal may then propagate through the first waveguide 203 in the first IC photonic structure 100.

As shown in FIG. 6A, the first waveguide 203 in the first IC photonic structure 100 may be separated from the second waveguide 209 in the second IC photonic structure 200 by a separation distance S1. The separation distance S1 may include the entire thickness of the VCIL structure 300. This may help minimize signal cross talk between the first IC photonic structure 100 and the second IC photonic structure 200.

Although FIGS. 6A and 6B illustrate resonator devices 601, 607 located within the first IC photonic structure 100 and the second IC photonic structure 200, in other embodiments, the VLIC structure 300 may include resonator(s) or other similar optical components that may enable vertical coupling of optical signals between the VLIC structure 300 and the first IC photonic structure 100 and/or the second IC photonic structure 200, and/or vertical coupling of optical signals between different levels (e.g. L1 and L2) of the VLIC structure 300.

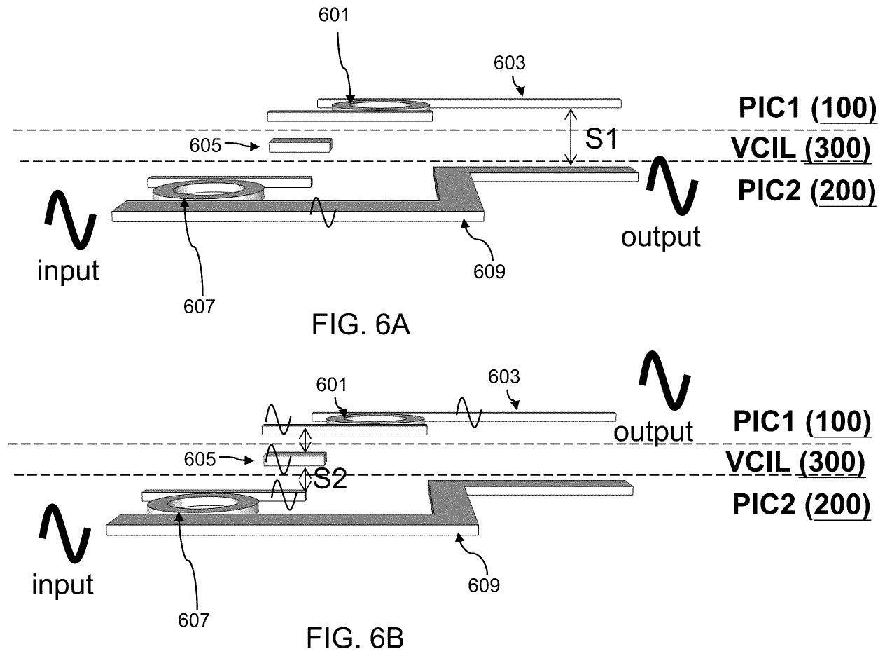

In various embodiments, a bonded photonic die 450 such as shown in FIGS. 4 and 5 may be incorporated into a semiconductor package. FIG. 7 is a vertical cross section view of a semiconductor package structure 460 according to an embodiment of the present disclosure. Referring to FIG. 7, a bonded photonic die 450 may be mounted to a support substrate 470 by a plurality of bonding structures 471. The bonded photonic die 450 may be similar to the bonded photonic die 450 described above with reference to FIG. 4, and may include a first IC electronic die 401 and a second IC photonic die 403 bonded to a bonded photonic structure 350. The bonded photonic structure 350 may include a VCIL structure 300 located between first IC photonic structure 100 and second IC photonic structure 200. The support substrate 470 may include a suitable support substrate, such as a package substrate, an interposer structure, or a printed circuit board (PCB). Other suitable support substrates are within the contemplated scope of disclosure. An additional die 455 may also be mounted to the support substrate 470 by a plurality of bonding structures 471. The additional die 455 may include a logic die, such as a system-on-chip (SOC) die, a CPU die, a GPU die, an ASIC die, etc. The additional die 455 and the bonded photonic die 450 may be mounted to the support substrate 470 by suitable bonding structures 471, such as solder connections, microbump bonding connections, wire bonds, etc. Electrical signals may be transmitted between the bonded photonic die 450 and the additional die 455 via the bonding structures 471 and conductive features located on and/or within the support substrate 470.

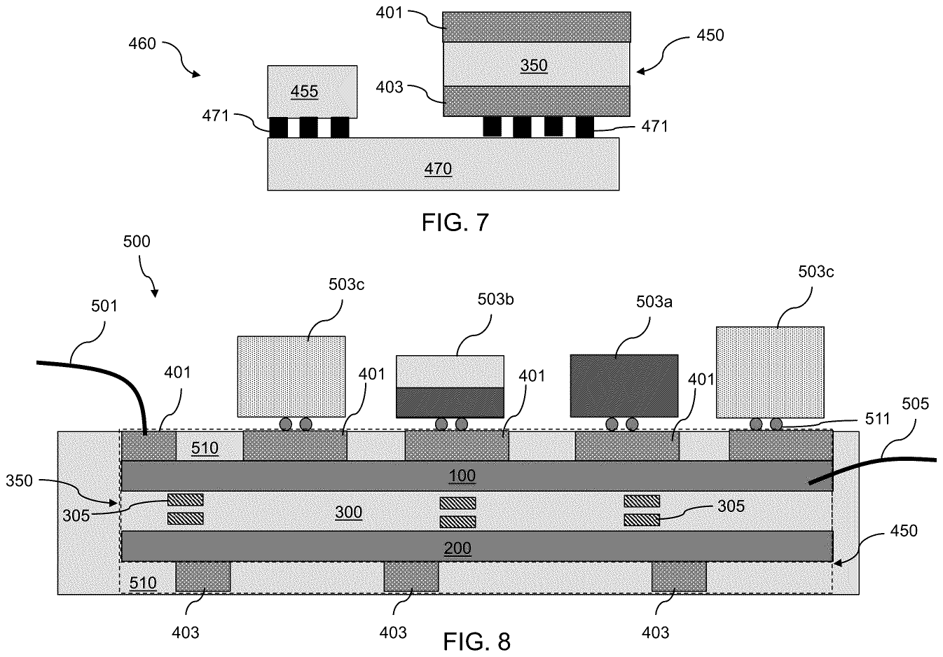

FIG. 8 is a vertical cross section view of a semiconductor package structure 500 according to another embodiment of the present disclosure. Referring to FIG. 8, the semiconductor package structure 500 may include a bonded photonic die 450 including a bonded photonic structure 350 as described above having a plurality of first IC electronic dies 401 bonded to a first IC photonic structure 100 of the bonded photonic structure 350, and a plurality of second IC electronic dies 403 bonded to a second IC photonic structure 200 bonded of the bonded photonic structure. A VLIC structure 300 may be located between the first IC photonic structure 100 and the second IC photonic structure 200 of the bonded photonic structure 350. In some embodiments, a fill material 510, such as a suitable dielectric material, may fill the spaces between the first IC electronic dies 401 and/or the second IC electronic dies 403 and may optionally laterally surround the bonded photonic structure 350.

Referring again to FIG. 8, a plurality of semiconductor dies 503a, 503b and 503c may be mounted to the bonded photonic die 450 via bonding structures 511, such as solder connections, microbump connections, direct bonding connections, etc. Each of the semiconductor dies 503a, 503b and 503c may be mechanically and electrically coupled to a first IC electronic die 401 of the bonded photonic die 450. In some embodiments, the semiconductor dies 503a, 503b and 503c may be homogeneous, meaning that all of the semiconductor dies 503a, 503b and 503c may be of the same type. Alternatively, the semiconductor dies 503a, 503b and 503c may be heterogeneous, meaning that semiconductor dies 503a, 503b and 503c may include different types of semiconductor dies that may provide different functions. For example, a first die 503a may be a logic die (e.g., an SOC die, a CPU die, a GPU die, an ASIC die, etc.), a second die 503b may include a three-dimensional die stack including multiple dies, and one or more third dies 503c may be a memory die, such as a high bandwidth memory (HBM) die, a dynamic random access memory (DRAM) die, etc.

In various embodiments, interconnections between all or a portion of the semiconductor dies 503a, 503b and 503c may be routed through the bonded photonic structure 350 of the bonded photonic die 450. Thus, the signals transmitted between different semiconductor dies 503a, 503b, 503c may include optical signals that may be routed, in part, through the first IC photonic structure 100, the second IC photonic structure 200 and the VCIL structure 300. This may provide increased bandwidth and may reduce signal loss due to localized heating or other thermal effects.

FIG. 8 additionally illustrates a first input/output component 501 (e.g., a wire) coupled to a first IC electronic die 401 for transmitting electrical signals to and/or from the semiconductor package structure 500 and a second input/output component 505 (e.g., an optical cable) coupled to the bonded photonic structure 350 for transmitting optical signals to and/or from the semiconductor package structure 500. In some embodiments, the semiconductor package structure 500 may be mounted onto a support structure (not shown in FIG. 8), such as a package substrate, an interposer or a PCB. Electrical connections to and/or from the semiconductor package structure 500 may be made through bonding structures located between the support structure and one or more of the second IC photonic dies 403.

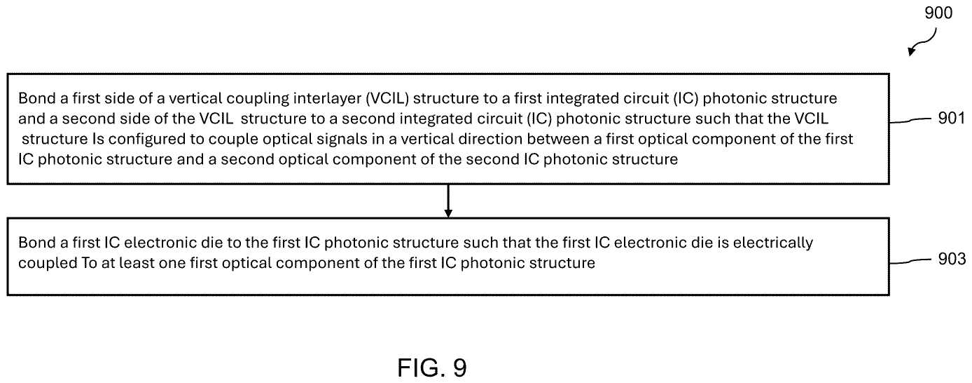

FIG. 9 is a flowchart illustrating a method 900 of fabricating a photonic device 450 according to various embodiments of the present disclosure. Referring to FIGS. 1A-3 and 9, in step 901 of method 900, a first side of a vertical coupling interlayer (VCIL) structure 300 may be bonded to a first integrated circuit (IC) photonic structure 100 and a second side of the VCIL structure 300 may be bonded to a second integrated circuit (IC) photonic structure 200 such that the VCIL structure 300 is configured to couple optical signals in a vertical direction between a first optical component 105 of the first IC photonic structure 100 and a second optical component 205 of the second IC photonic structure 200. Referring to FIGS. 4, 5 and 9, in step 903 of method 900, a first IC electronic die 401 may be bonded to the first IC photonic structure 100 such that the first IC electronic die 401 is electrically coupled to at least one first optical component 105 of the first IC photonic structure 100.

Referring to all drawings and according to various embodiments of the present disclosure, a bonded photonic die 450 includes a first integrated circuit (IC) photonic structure 100 including a first semiconductor layer 103 including a plurality of first optical components 105, and a first interconnect structure 106 including conductive interconnect features 108 formed in a dielectric material 107, a second IC photonic structure 200 including a second semiconductor layer 203 including a plurality of second optical components 205, a vertical coupling interlayer (VCIL) structure 300 located between the first IC photonic structure 100 and the second IC photonic structure 200, the VCIL structure 300 including at least one third optical component 305 formed in a dielectric material 303, the at least one third optical component 305 located between and vertically overlapping with at least one first optical component 105 in the first semiconductor layer 103 of the first IC photonic structure 100 and at least one second optical component 205 in the second semiconductor layer 203 of the second IC photonic structure 200 such that the at least one third optical component 305 couples optical signals between the first IC photonic structure 100 and the second IC photonic structure 200 along a vertical direction, and a first IC electronic die 401 bonded to the first IC photonic structure 100, where the conductive interconnect features 108 of the first interconnect structure 106 of the first IC photonic structure 100 electrically couple the first IC electronic die 401 to at least a portion of the first optical components 105 of the first IC photonic structure 100.

In one embodiment, the at least one third optical component 305 includes silicon or silicon nitride, and the dielectric material 303 of the VCIL structure 300 includes an oxide material.

In another embodiment, each of the third optical components 305 includes a passive optical component in which the functionality of the third optical component 305 does not require an electrical input.

In another embodiment, the second IC photonic structure 200 includes a second interconnect structure 206 including conductive interconnect features 208 embedded in a dielectric material 207, the bonded photonic die 450 further including a second IC electronic die 403 bonded to the second IC photonic structure 200, where the conductive interconnect features 208 of the second interconnect structure 206 of the second IC photonic structure 200 electrically couple the second IC electronic die 403 to at least a portion of the second optical components 205 of the second IC photonic structure 200.

In another embodiment, the VCIL structure 300 includes an optical transmission region 307 that includes one or more third optical components 305 and an optical isolation region 309 that does not include any third optical components 305, where the optical isolation region 309 is located between one or more first optical components 105 of the first IC photonic structure 100 and one or more second optical components 205 of the second IC photonic structure 200.

In another embodiment, the VCIL structure 300 includes at least one third optical component 305 in a first level L1 and at least one third optical component 305 in a second level L2 that is vertically separated from the first level L1, and the dielectric material 303 of the VCIL structure 300 is located between the at least one third optical component 305 in the first level L1 and the at least one third optical component 305 in the second level L2.

In another embodiment, the bonded photonic die 450 further includes a first bonding interface 315 between the first IC photonic structure 100 and the VCIL structure 300, and a second bonding interface 320 between the second IC photonic structure 200 and the VCIL structure 300, where the first IC photonic structure 100 further includes a first insulator layer 101 located between the first bonding interface 315 and the first semiconductor layer 103, the second IC photonic structure 200 further includes a second insulator layer 201 located between the second bonding interface 320 and the second semiconductor layer 203, and the dielectric material 303 of the VCIL structure 300 is located between the at least one third optical component 305 and the first bonding interface 315 and between the at least one third optical component 305 and the second bonding interface 320.

In another embodiment, optical signals are vertically coupled across the first bonding interface 315 between a first optical component 105 of the first IC photonic structure 100 and a third optical component 305 of the VCIL structure 300, and optical signals are vertically coupled across the second bonding interface 320 between a second optical component 205 of the second IC photonic structure 200 and a third optical component 305 of the VCIL structure 300.

In another embodiment, optical signals are vertically coupled between the first optical component 105 of the first IC photonic structure 100 and the third optical component 305 of the VCIL structure 300 and/or between the second optical component 205 of the second IC photonic structure 200 and the third optical component 305 of the VCIL structure 300 by at least one of diffractive coupling, an inverted taper vertical coupler, evanescent coupling, adiabatic coupling, direct butt coupling, and wavelength-selective vertical coupling.

In another embodiment, optical signals are vertically coupled between the first optical component 105 of the first IC photonic structure 100 and the third optical component 305 of the VCIL structure 300 and/or between the second optical component 205 of the second IC photonic structure 200 and the third optical component 305 of the VCIL structure 300 by wavelength-selective vertical coupling, and wherein at least one of the first optical component 100, the second optical component 200 and the third optical component 305 comprises a resonator 601, 607.

In another embodiment, the first IC photonic structure 100 includes a first resonator 601 and a first waveguide 605, the second IC photonic structure 200 includes a second resonator 607 and a second waveguide 609, and the VCIL structure 300 includes a third waveguide 605, optical signals having a first wavelength are coupled in a lateral direction from the first resonator 601 into the first waveguide 603, and optical signals having a second wavelength are coupled in a vertical direction from the first resonator 601 to the third waveguide 605 and from the third waveguide 605 to the second resonator 607, and are coupled in a lateral direction from the second resonator 607 into the second waveguide 609.

In another embodiment, the first IC electronic die 401 is bonded to the first IC photonic structure 100 by a pair of bonding layers 351 including metal bonding pads 355 surrounded by a dielectric material 353, the pair of bonding layers 351 forming a bonding interface 358.

Another embodiment is drawn to a device structure 460, 500 including a semiconductor die 455, 503a, 503b, 503c and a bonded photonic die 450, the bonded phonic die 450 including a first integrated circuit (IC) photonic structure 100, a second IC photonic structure 200, a vertical coupling interlayer (VCIL) structure 300 bonded to the first IC photonic structure 100 at a first bonding interface 315 and to the second IC photonic structure 200 at a second bonding interface 320 and configured to couple optical signals between the first IC photonic structure 100 and the second IC photonic structure 200, and a first IC electronic die 401 bonded to the first IC photonic structure 100 and configured to provide an interface between electronic and photonic components of the device structure 460, 500, where the first IC electronic die 401 is electrically connected to the semiconductor die 455, 503a, 503b, 503c.

In an embodiment, first IC photonic structure 100 is configured to convert optical signals to electronic signals that are read-out by the first IC electronic die 401, and the first IC electronic die 401 is configured to provide electronic signals to the first IC photonic structure 100 that are converted to optical signals.

In another embodiment, the semiconductor die 455, 503a, 503b, 503c and the bonded photonic die 450 are mounted to a common substrate 470.

In another embodiment, the bonded photonic die 450 includes a plurality of first IC electronic dies 401 bonded to the first IC photonic structure 100, and the device structure 460, 500 includes a plurality of semiconductor dies 503a, 503b, 503c mounted to the first IC electronic dies 401, where signals transmitted between different semiconductor dies 503a, 503b, 503c include optical signals that are routed, in part, through the first IC photonic structure 100, the second IC photonic structure 200 and/or the VCIL structure 300.

Another embodiment is drawn to a method of fabricating a photonic device that includes bonding a first side of a vertical coupling interlayer (VCIL) structure 300 to a first integrated circuit (IC) photonic structure 100 and a second side of the VCIL structure 300 to a second integrated circuit (IC) photonic structure 200 such that the VCIL structure 300 is configured to couple optical signals in a vertical direction between a first optical component 105 of the first IC photonic structure 100 and a second optical component 205 of the second IC photonic structure 200, and bonding a first IC electronic die 401 to the first IC photonic structure 100 such that the first IC electronic die 401 is electrically coupled to at least one first optical component 105 of the first IC photonic structure 100.

In an embodiment, the VCIL structure includes a substrate 310, a dielectric material 303 over the substrate and at least one third optical component 305 formed within the dielectric material 303, and where bonding the first side of the VCIL structure 300 to the first IC photonic structure 100 and the second side of the VCIL structure 300 to the second IC photonic structure 200 includes bonding the dielectric material 303 of the VCIL structure 300 to a second insulator layer 201 of the second IC photonic structure 200 via a fusion bonding process, removing the substrate 310 of the VCIL structure 300, and bonding the dielectric material 303 of the VCIL structure 300 to a first insulator layer 101 of the first IC photonic structure 100 via a fusion bonding process.

In another embodiment, the method further includes bonding a second IC electronic die 403 to the second IC photonic structure 200 such that the second IC electronic die 403 is electrically coupled to at least one second optical component 205 of the second IC photonic structure 200.

In another embodiment, the first IC electronic die 401 is bonded to the first IC photonic structure 100 and the second IC electronic die 403 is bonded to the second IC photonic structure 200 via metal-to-metal and dielectric-to-dielectric direct bonding processes.

The foregoing outlines features of several embodiments so that those skilled in the art may better understand the aspects of the present disclosure. Those skilled in the art should appreciate that they may readily use the present disclosure as a basis for designing or modifying other processes and structures for achieving the same purposes and/or the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A bonded photonic die, comprising:
a first integrated circuit (IC) photonic structure, comprising:
a first semiconductor layer comprising a plurality of first optical components; and
a first interconnect structure comprising conductive interconnect features formed in a dielectric material;
a second IC photonic structure comprising a second semiconductor layer comprising a plurality of second optical components;
a vertical coupling interlayer (VCIL) structure located between the first IC photonic structure and the second IC photonic structure, the VCIL structure comprising at least one third optical component formed in a dielectric material, the at least one third optical component located between and vertically overlapping with at least one first optical component in the first semiconductor layer of the first IC photonic structure and at least one second optical component in the second semiconductor layer of the second IC photonic structure such that the at least one third optical component couples optical signals between the first IC photonic structure and the second IC photonic structure along a vertical direction; and
a first IC electronic die bonded to the first IC photonic structure, wherein the conductive interconnect features of the first interconnect structure of the first IC photonic structure electrically couple the first IC electronic die to at least a portion of the plurality of first optical components of the first IC photonic structure.

2. The bonded photonic die of claim 1, wherein the at least one third optical component comprises silicon or silicon nitride, and the dielectric material of the VCIL structure comprises an oxide material.

3. The bonded photonic die of claim 1, wherein each of the third optical components comprises a passive optical component in which the functionality each of the third optical component does not require an electrical input.

4. The bonded photonic die of claim 1, wherein the second IC photonic structure comprises a second interconnect structure comprising conductive interconnect features embedded in a dielectric material, the bonded photonic die further comprising:
a second IC electronic die bonded to the second IC photonic structure, wherein the conductive interconnect features of the second interconnect structure of the second IC photonic structure electrically couple the second IC electronic die to at least a portion of the plurality of second optical components of the second IC photonic structure.

5. The bonded photonic die of claim 1, wherein the VCIL structure includes an optical transmission region that includes one or more third optical components and an optical isolation region that does not include any third optical components, wherein the optical isolation region is located between one or more first optical components of the first IC photonic structure and one or more second optical components of the second IC photonic structure.

6. The bonded photonic die of claim 1, wherein the VCIL structure includes at least one third optical component in a first level and at least one third optical component in a second level that is vertically separated from the first level, and the dielectric material of the VCIL structure is located between the at least one third optical component in the first level and the at least one third optical component in the second level.

7. The bonded photonic die of claim 1, further comprising:
a first bonding interface between the first IC photonic structure and the VCIL structure; and
a second bonding interface between the second IC photonic structure and the VCIL structure, wherein:
the first IC photonic structure further comprises a first insulator layer located between the first bonding interface and the first semiconductor layer;
the second IC photonic structure further comprises a second insulator layer located between the second bonding interface and the second semiconductor layer; and
the dielectric material of the VCIL structure is located between the at least one third optical component and the first bonding interface and between the at least one third optical component and the second bonding interface.

8. The bonded photonic die of claim 7, wherein optical signals are vertically coupled across the first bonding interface between a first optical component of the first IC photonic structure and a third optical component of the VCIL structure, and optical signals are vertically coupled across the second bonding interface between a second optical component of the second IC photonic structure and a third optical component of the VCIL structure.

9. The bonded photonic die of claim 8, wherein optical signals are vertically coupled between the first optical component of the first IC photonic structure and the third optical component of the VCIL structure and/or between the second optical component of the second IC photonic structure and the third optical component of the VCIL structure by at least one of diffractive coupling, an inverted taper vertical coupler, evanescent coupling, adiabatic coupling, direct butt coupling, and wavelength-selective vertical coupling.

10. The bonded photonic die of claim 9, optical signals are vertically coupled between the first optical component of the first IC photonic structure and the third optical component of the VCIL structure and/or between the second optical component of the second IC photonic structure and the third optical component of the VCIL structure by wavelength-selective vertical coupling, and wherein at least one of the first optical component, the second optical component and the third optical component comprises a resonator.

11. The bonded photonic die of claim 10, wherein the first IC photonic structure comprises a first resonator and a first waveguide, the second IC photonic structure comprises a second resonator and a second waveguide, and the third IC photonic structure comprises a third waveguide,
optical signals having a first wavelength are coupled in a lateral direction from the first resonator into the first waveguide, and
optical signals having a second wavelength are coupled in a vertical direction from the first resonator to the third waveguide and from the third waveguide to the second resonator, and are coupled in a lateral direction from the second resonator into the second waveguide.

12. The bonded photonic die of claim 1, wherein the first IC electronic die is bonded to the first IC photonic structure by a pair of bonding layers comprising metal bonding pads surrounded by a dielectric material, the pair of bonding layers forming a bonding interface.

13. A device structure, comprising:
a semiconductor die; and
a bonded photonic die comprising:
a first integrated circuit (IC) photonic structure;
a second IC photonic structure;
a vertical coupling interlayer (VCIL) structure bonded to the first IC photonic structure at a first bonding interface and to the second IC photonic structure at a second bonding interface and configured to couple optical signals between the first IC photonic structure and the second IC photonic structure; and
a first IC electronic die bonded to the first IC photonic structure and configured to provide an interface between electronic and photonic components of the device structure, wherein the first IC electronic die is electrically connected to the semiconductor die.

14. The device structure of claim 13, wherein the first IC photonic structure is configured to convert optical signals to electronic signals that are read-out by the first IC electronic die, and the first IC electronic die is configured to provide electronic signals to the first IC photonic structure that are converted to optical signals.

15. The device structure of claim 13, wherein the semiconductor die and the bonded photonic die are mounted to a common substrate.

16. The device structure of claim 13, wherein the bonded photonic die comprises a plurality of first IC electronic dies bonded to the first IC photonic structure, and the device structure comprises a plurality of semiconductor dies mounted to the first IC electronic dies, wherein signals transmitted between different semiconductor dies include optical signals that are routed, in part, through the first IC photonic structure, the second IC photonic structure and/or the VCIL structure.

17. A method of fabricating a photonic device, comprising:
bonding a first side of a vertical coupling interlayer (VCIL) structure to a first integrated circuit (IC) photonic structure and a second side of the VCIL structure to a second integrated circuit (IC) photonic structure such that the VCIL structure is configured to couple optical signals in a vertical direction between a first optical component of the first IC photonic structure and a second optical component of the second IC photonic structure; and
bonding a first IC electronic die to the first IC photonic structure such that the first IC electronic die is electrically coupled to at least one first optical component of the first IC photonic structure.

18. The method of claim 17, wherein the VCIL structure comprises a substrate, a dielectric material over the substrate and at least one third optical component embedded in the dielectric material, and wherein bonding the first side of the VCIL structure to the first IC photonic structure and the second side of the VCIL structure to the second IC photonic structure comprises:
bonding the dielectric material of the VCIL structure to a second insulator layer of the second IC photonic structure via a fusion bonding process; and
bonding the dielectric material of the VCIL structure to a first insulator layer of the first IC photonic structure via a fusion bonding process.

19. The method of claim 17, further comprising:
bonding a second IC electronic die to the second IC photonic structure such that the second IC electronic die is electrically coupled to at least one second optical component of the second IC photonic structure.

20. The method of claim 19, wherein the first IC electronic die is bonded to the first IC photonic structure and the second IC electronic die is bonded to the second IC photonic structure via metal-to-metal and dielectric-to-dielectric direct bonding processes.
